(19) United States
(12) Patent Application Publication
(10) Pub. No.: US 2025/0361927 A1
(43) Pub. Date: Nov. 27, 2025

(54) DRIVE CLUTCH

(71) Applicant: Arctic Cat Inc., Thief River Falls, MN (US)

(72) Inventors: Jayden Alan Trana, Thief River Falls, MN (US); Samuel J. Sandoz, Thief River Falls, MN (US); Brockton Rohloff, Thief River Falls, MN (US)

(21) Appl. No.: 19/215,860

(22) Filed: May 22, 2025

Related U.S. Application Data
(60) Provisional application No. 63/651,508, filed on May 24, 2024.

(51) Int. Cl. F16H 9/14; F16H 57/00

(52) U.S. Cl. CPC F16H 9/14; F16H 57/00; F16D 2250/0084

(57) ABSTRACT

A continuously variable transmission (CVT) drive clutch includes a stationary sheave and a stationary shaft coupled to the stationary sheave. A movable sheave is movable relative to the stationary sheave. The movable sheave includes a tower having a cavity therein. A cover is securable to the movable sheave via a fastener extending into the cavity of the tower. An elongate member is received within the cavity of the tower.

### TECHNICAL FIELD

The subject matter disclosed herein relates to a continuously variable transmission (CVT) for a vehicle and, in particular, to a CVT drive clutch.

### BACKGROUND

In general, a CVT drive clutch includes a stationary sheave and stationary shaft coupled to a movable sheave, and a spider body secured to the movable sheave. The movable sheave or spider includes one or more towers coupled to a cover. In some cases, the spider body or moveable sheave includes a torque transfer assembly abutting adjacent towers of the movable sheave or spider. The CVT drive clutch rotates, generating high inertial forces and is subject to impact forces as the vehicle (e.g., an offroad vehicle and/or snow vehicle) travels over terrain. The inertial and/or impact forces can cause the towers of the movable sheave or spider to bend or deform over time which thereby degrades performance of the CVT drive clutch.

### SUMMARY

According to one aspect, a continuously variable transmission (CVT) drive clutch includes a stationary sheave and a stationary shaft coupled to the stationary sheave. A movable sheave is movable relative to the stationary sheave. The movable sheave includes a tower having a cavity therein. A cover is securable to the movable sheave via a fastener extending into the cavity of the tower. An elongate member is received within the cavity of the tower.

According to another aspect, a system for servicing a continuously variable transmission (CVT) drive clutch. The system includes a CVT drive clutch including a stationary sheave and a stationary shaft coupled to the stationary sheave. A movable sheave is movable relative to the stationary sheave and receives the stationary shaft therethrough. The movable sheave includes one or more channels recessed within a surface. A cover is securable to the movable sheave. A spider is positioned between the movable sheave and the cover. A spring member biases the movable sheave axially away from the stationary sheave. A stop member includes a locking ridge. The locking ridge is configured to be received within the one or more channels of the movable sheave.

According to another aspect, a method of servicing a continuously variable transmission (CVT) drive clutch. A movable sheave of the CVT drive clutch is urged toward the stationary sheave to create a gap between a spider and the movable sheave. The CVT drive clutch includes the stationary sheave, the movable sheave, a spring member biased to urge the movable sheave axially away from the stationary sheave, the spider, and a cover coupled to a tower of the movable sheave. A stop member is inserted into the gap between the spider and the movable sheave. One or more components is removed from the CVT drive clutch a method of servicing a CVT drive clutch includes providing a CVT drive clutch. A spring member is compressed to create a gap between the spider and the movable sheave. A stop member is inserted between the spider and the movable sheave to hold a gap therebetween. One or more components are removed or serviced from the CVT drive clutch.

### BRIEF DESCRIPTION OF THE DRAWINGS

FIG. 1 is an isometric view of a CVT drive clutch, according to some embodiments.

FIG. 2 is an exploded isometric view of a CVT drive clutch, according to some embodiments.

FIG. 3 is a cross-sectional view of a connection between a cover and a tower of a CVT drive clutch, according to some embodiments.

FIG. 4 is an isometric view of a CVT drive clutch including an identification member, according to some embodiments.

FIG. 5A is an isometric view of a stop member for servicing a CVT drive clutch, according to some embodiments,

FIG. 5B is an isometric view of a stop member for servicing a CVT drive clutch, according to some embodiments.

FIG. 6 is a side view of the CVT drive clutch with a stop member positioned between a spider and a movable sheave, according to some embodiments.

FIG. 7A is a cross-sectional view of a stop member engaging a movable sheave, according to some embodiments,

FIG. 7B is a cross-sectional view of a stop member engaging with a movable sheave, according to some embodiments.

FIG. 8 is a flow chart of a method of servicing a CVT drive clutch, according to some embodiments.

### DETAILED DESCRIPTION

The present disclosure describes a CVT drive clutch for an off-road vehicle. The CVT drive clutch includes a spider axially fixed relative to a stationary sheave and a stationary shaft. The CVT drive clutch includes a movable sheave or spider including one or more towers coupled to a cover via a fastener (i.e., a bolt). The CVT drive clutch generally rotates at speeds between 2,500 RPM and 9,000 RPM during vehicle operation, thereby generating high inertial forces. The off-road vehicle can experience significant impact forces, including for example, impact forces from traveling over uneven or rough terrain. In some cases, the inertial forces and/or impact forces may cause the one or more towers of the movable sheave or spider to flex, shift, or otherwise travel relative to the movable sheave. The CVT drive clutch includes an elongate member received within the tower and the cover. The elongate member may include a pin or dowel pin having an aperture therethrough. The fastener is inserted (at least partially) through the elongate member, the cover, and the tower to secure the cover to the tower. The structural strength of the elongate member and press fit between the elongate member and the cover/tower prevents travel of the tower relative to the adjoining movable sheave or spider.

The CVT drive clutch includes components that are replaceable. For example, components of a torque transfer assembly can be worn, requiring replacement parts to be substituted. In other cases, weights rollers, and sliders can be added/removed to customize CVT performance. To service the CVT drive clutch without disassembly of the cover from the movable sheave (which can void a user's warranty), a stop member is provided to hold a gap between the movable sheave and the spider. The gap provides enough space for a user (or mechanic) to easily service parts.

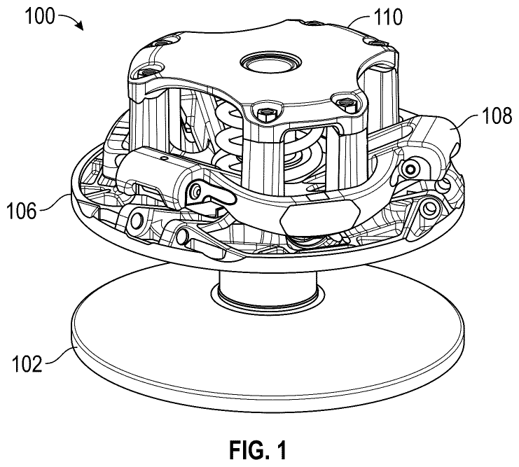

FIG. 1 is an isometric view of a CVT drive clutch 100 for an off-road vehicle, according to some embodiments. The CVT drive clutch 100 includes a stationary sheave 102, a movable sheave 106, a spider 108, and a cover 110, according to some embodiments. The spider 108 is fixed relative to the stationary sheave 102, according to some embodiments. The movable sheave 106 is biased axially away from the stationary sheave 102 (e.g., via a spring member urging the cover 110), according to some embodiments. In some embodiments, the CVT drive clutch 100 includes features of the CVT drive clutch described in commonly-owned U.S. application Ser. No. 18/195,163 filed on May 9, 2023, and entitled “Continuously variable transmission for recreational vehicles and related components,” the contents of which are incorporated by reference.

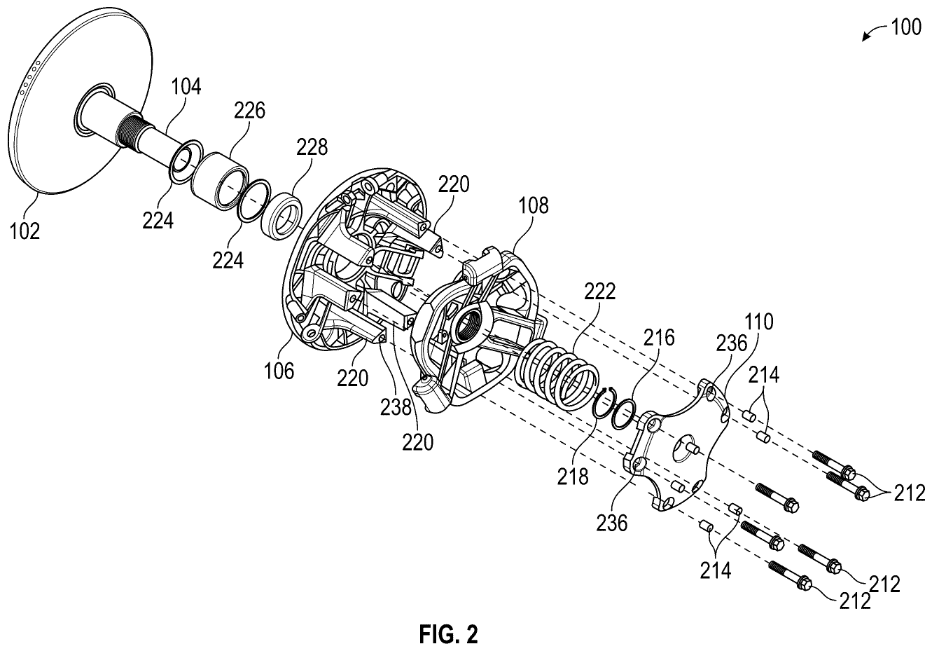

FIG. 2 is an exploded isometric view of the CVT drive clutch 100, according to some embodiments. The CVT drive clutch 100 includes a stationary shaft 104, a fastener 212, an elongate member 214, a shift stop 216, a snap ring 218, a spring member 222, a tower 220, a collar 228, a thrust washer 224, and an idler bearing 226, according to some embodiments. The movable sheave 106 includes one or more towers 220, according to some embodiments. The one or more towers 220 extend in an axial direction from the movable sheave 106 to couple the movable sheave 106 to the cover 110. In some embodiments, portions of the spider 108 are received between adjacent towers of the one or more towers 220, such that the one or more towers 220 engage a surface of the spider 108 (e.g., a button slider block of a button slider block assembly).

The fastener 212 may be configured to be received within the elongate member 214, including for instance, through an aperture of the elongate member 214. The fastener 212 and the elongate member 214 may be configured to be received within an aperture 236 in the cover 110 and receive within a cavity 238 in the tower 220. The elongate member 214 may include a pin and/or a dowel pin. The fastener 212 and the elongate member 214 (or the plurality of fasteners 212 and the plurality of elongate member 214, in some embodiments) are configured to secure the movable sheave 106 to the cover 110, thereby securing the spider 108 and the spring member 222 therebetween. In some embodiments, the spring member 222 is compressed between the spider 108 and the cover 110 to bias the movable sheave 106 axially away from the stationary sheave 102.

The one or more towers 220 are subjected to high inertial and/or impact forces during vehicle operation. In some cases, the high inertial and/or impact forces can cause the one or more towers 220 to travel (relative to the movable sheave 106) over time, thereby changing spacing between adjacent towers. The fastener 212 and the elongate member 214 are configured to improve structural support of the connection between the cover 110 and the one or more towers 220 such that the one or more towers 220 are firmly fixed in-place relative to the movable sheave 106. The elongate member 214 received within the tower 220 and/or the cover 110 may be beneficial to improve durability of the CVT drive clutch 100 by reducing travel of the one or more towers 220 relative to the movable sheave 106 due to the high inertial and/or impact forces.

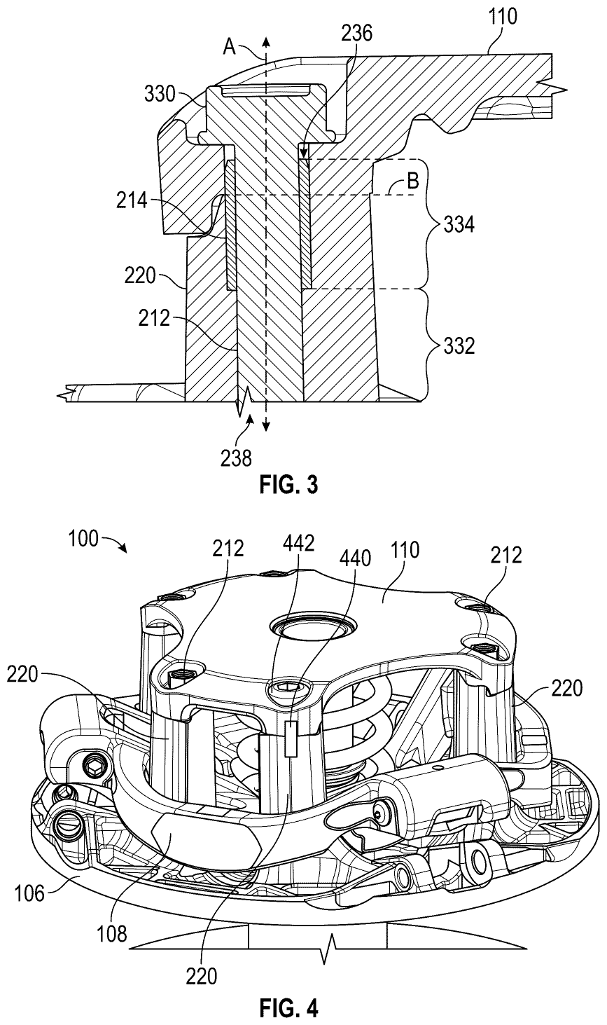

FIG. 3 is a cross-sectional view of a connection between the cover 110 and the tower 220, according to some embodiments. The boundary between the cover 110 and the tower 220 is indicated by line B. The fastener 212 includes a head 330, a first portion 332, and a second portion 334, according to some embodiments. The first portion 332 of the fastener 212 may include a threaded surface (not shown) to threadingly couple to the cavity 238 of the tower 220, according to some embodiments. The second portion 334 of the fastener 212 is not threaded. The second portion 334 of the fastener 212 forms a precision clearance fit (i.e., slip fit) with the inner surface of the elongate member 214, according to some embodiments. The outer surface of the elongate member 214 forms a precision friction fit with the aperture 236 of the cover 110 and/or forms a precision friction fit with the cavity 238 of the tower 220, according to some embodiments.

In some embodiments, the cover 110 and the tower 220 are formed of a first material (e.g., aluminum) and the elongate member 214 is formed of a second material (e.g., steel). The second material has a greater hardness and/or stiffness than the first material, according to some embodiments.

In some embodiments, the elongate member 214 extends within both the aperture 236 of the cover 110 and the cavity 238 of the tower 220, or in other words, the elongate member 214 extends across the boundary B between the cover 110 and the tower 220. The elongate member 214 provides alignment and structural strength to the joint or assembly between the cover 110 and the tower 220. For instance, a longitudinal axis A of the fastener 212 is aligned (e.g., centered and parallel) with the aperture 236 and with the cavity 238, according to some embodiments. In some embodiments, the cavity 238 of the tower 220 includes two portions, the first being a threaded portion to threadingly couple with the first portion 332 of the fastener 212, and the second being a straight wall for the second portion 334 of the fastener 212 to engage with. In some embodiments, the first and second portion of the cavity 238 have different diameters, e.g., the second portion being a larger diameter than the first diameter to leave space for the elongate member 214. In some embodiments, a shoulder or ridge separates the first and second portion of the cavity 238 such that the elongate member 214 abuts or rests on the shoulder or ridge to provide proper insertion depth of the elongate member 214 into the tower 220.

The elongate member 214 prevents travel between the fastener 212 and the cover 110 and/or the tower 220. If, for example, the elongate member 214 was removed, there would be open space between the fastener 212 and the aperture 236 and there would be open space between the fastener 212 and the cavity 238. In such case, the fastener 212 could travel (in a direction orthogonal to the longitudinal axis A) relative to the aperture 236 and/or the cavity 238. The elongate member 214 inhibits travel of the fastener 212 relative to the aperture 236 and/or the cavity 238, thereby guaranteeing proper alignment of the tower 220 relative to the cover 110.

The elongate member 214 provides a low-cost, efficient, and reliable solution to the problem of maintaining proper tower alignment. For example, the space between the fastener 212 and the aperture 236 and/or the cavity 238 could be minimized by precision manufacturing of the fastener 212, e.g., via precision milling of the diameter of the shaft of the fastener 212. However, precision manufacturing of threaded fasteners is extremely costly and labor intensive. The elongate member 214 therefore provides a low-cost, efficient precision interface between multiple components (the cover 110, the tower 220, the fastener 212) which improves alignment and strengthens the connection between the cover 110 and the tower 220.

FIG. 4 is an isometric view of a CVT drive clutch 100 including an identification member 440, according to some embodiments. The identification member 440 is coupled to the cover 110 and the tower 220, i.e., the identification member 440 extends across the interface between the cover 110 and the tower 220. In some embodiments, the identification member 440 includes an adhesive configured to adhere to the cover 110 and the tower 220. If the cover 110 is removed from the CVT drive clutch 100, e.g., via removing the one or more fasteners 212, the identification member 440 is damaged. For example, the identification member 440 can be torn in half if the cover 110 is removed, or in other embodiments, the adhesive on the identification member 440 cannot adhere (or be re-applied) to the cover 110 and/or the tower 220 once the cover 110 is removed. The identification member 440 will thereby communicate whether the cover 110 has been removed by a user or mechanic, which in some cases, may void the vehicle warranty.

In some embodiments, a second identification member 442 can be positioned over the head of the fastener 212. Thus, if the fastener 212 is removed from the CVT drive clutch 100 (thereby allowing the cover 110 to be removed), the second identification member 442 is damaged or removed. In some embodiments, the identification member 440 and the second identification member 442 can be used together (i.e., on the same CVT drive clutch), while in other embodiments, either the identification member 440 or the second identification member 442 can be used on a CVT drive clutch. In some embodiments, a plurality of identification members 440 and/or a plurality of second identification members 442 can be used on the CVT drive clutch 100 (e.g., on each of the fasteners and/or each of the towers). The identification member 440 and the second identification member 442 can also be referred to a tamper identification indicators, as the identification member 440 and the second identification member 442 will identify whether the CVT drive clutch 100 has been tampered with.

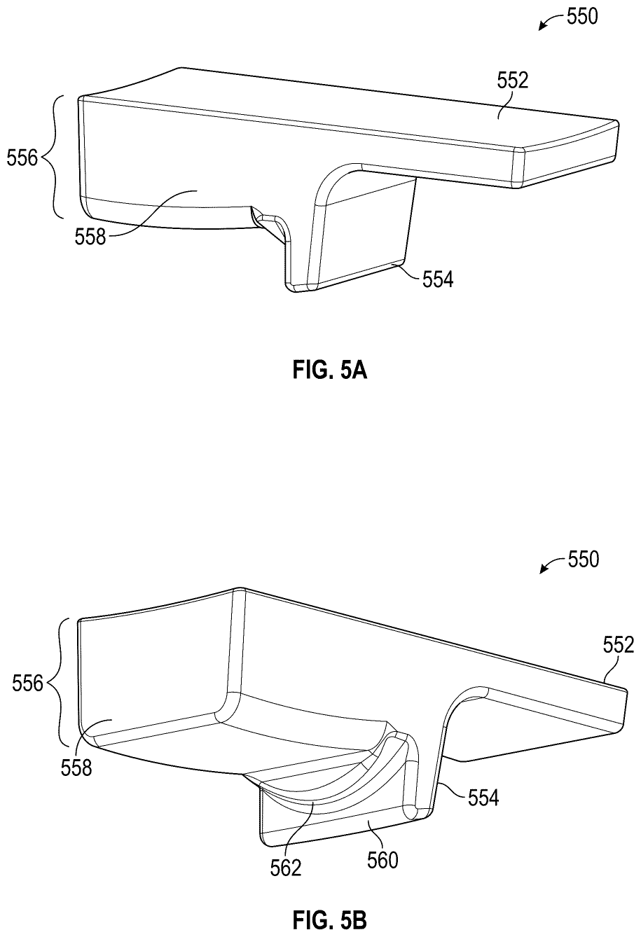

FIGS. 5A-B are isometric views of a stop member 550 for servicing a CVT drive clutch, according to some embodiments. The stop member 550 includes a handle 552, a locking ridge 554, a body 558 defining a height 556, an engagement surface 560, and a secondary alignment ridge 562, according to some embodiments. The handle 552 and the locking ridge 554 extend from the body 558 and are oriented substantially orthogonal (e.g., 90° #) 15° to each other. The handle 552 is configured to provide a surface for the user to interface with, i.e., the user can position the stop member 550 via interfacing with the handle 552. The locking ridge 554 is configured to engage with and/or mate with a surface of the movable sheave 106, according to some embodiments. The engagement between the locking ridge 554 and the surface of the movable sheave 106 prevents the stop member 550 from being removed from, or disengaging with, the CVT drive clutch.

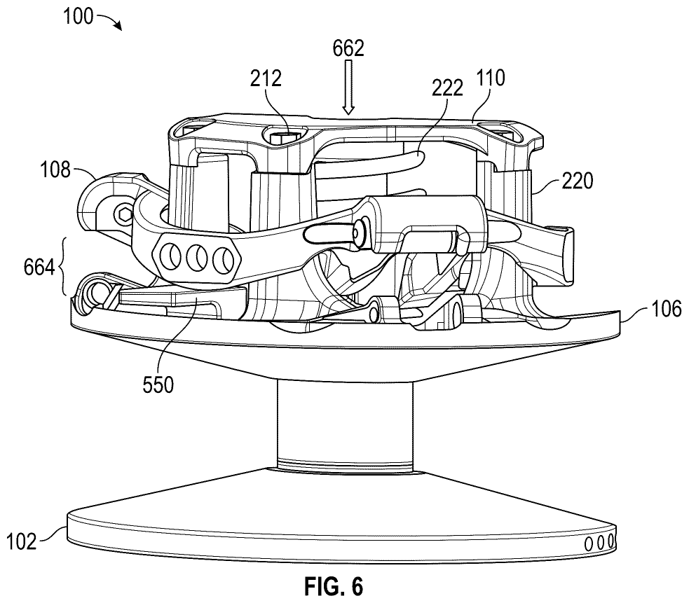

FIG. 6 is a side view of the CVT drive clutch 100 with a stop member 550 positioned between the spider 108 and the movable sheave 106, according to some embodiments. The spider 108 is spaced from (or separated from) the movable sheave 106 by a gap 664 via the stop member 550, according to some embodiments. Spacing or separating the spider 108 from the movable sheave 106 allows a user (or mechanic) to service one or more components of the CVT drive clutch 100. For example, a cam arm, torque transfer assembly, a button block assembly, and/or weights, as described in commonly-owned U.S. application Ser. No. 18/195,163 filed on May 9, 2023, and entitled “Continuously variable transmission for recreational vehicles and related components,” the contents of which are incorporated by reference, can be serviced and/or replaced without removing the cover 110 from the CVT drive clutch 100.

In some embodiments, to insert the stop member 550 between the spider 108 and the movable sheave 106, the user must apply a force to the cover 110, as indicated by arrow 662. Applying force along the arrow 662 compresses the spring member 222 and urges the movable sheave 106 toward the stationary sheave 102. The spider 108, which is axially fixed relative to the stationary sheave 102, separates from the movable sheave 106 (with the movable sheave 106 moving in a direction parallel with the arrow 662). The spring member 222 is compressed and is biased to urge the movable sheave 106 away from the stationary sheave 102. Thus, as force is applied along the arrow 662, the user can insert the stop member 550 between the spider 108 and the movable sheave 106 to hold the gap 664 between the spider 108 and the movable sheave 106.

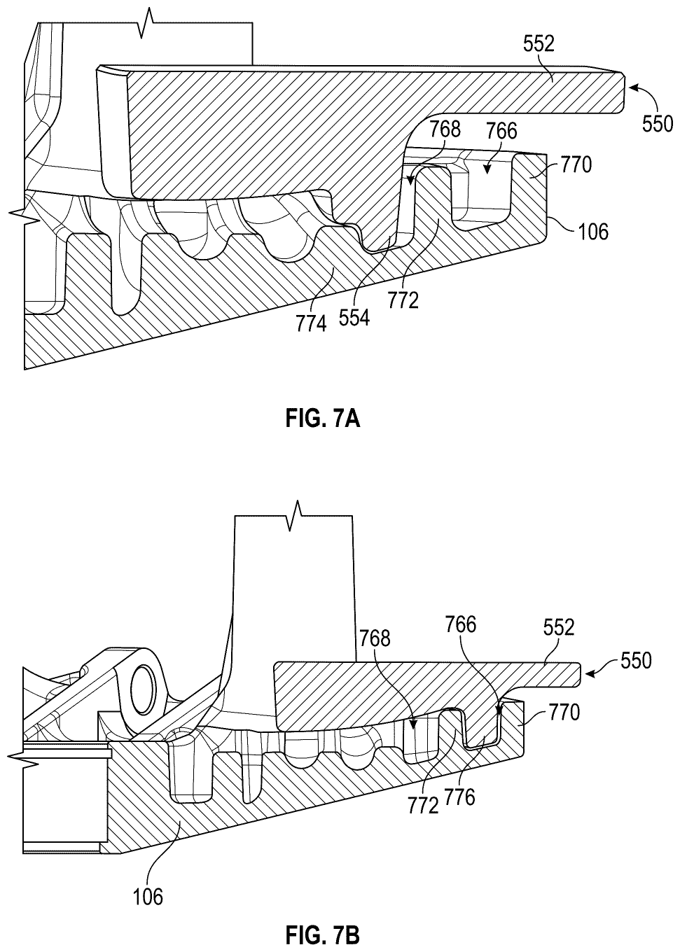

FIG. 7A is a cross-sectional view of the stop member 550 engaging with the movable sheave 106, according to some embodiments. The movable sheave 106 includes a first rib 770, a second rib 772, and a third rib 774, A first channel 766 is formed between the first rib 770 and the second rib 772, and a second channel 768 is formed between the second rib 772 and the third rib 774. The locking ridge 554 engages the third rib 774 and/or the second channel 768 to secure the stop member 550 in-place, according to some embodiments.

FIG. 7B is a cross-sectional view of the stop member 550 engaging with the movable sheave 106, according to some embodiments. The stop member 550 includes a second locking ridge 776. The second locking ridge 776 engages the first channel 766 and/or the first rib 770 and the second rib 772 to secure the stop member 550 in-place, according to some embodiments.

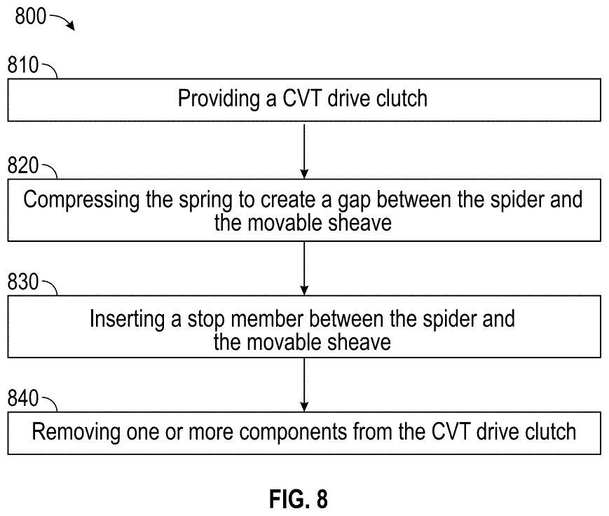

FIG. 8 is a flow chart of a method 800 of servicing a CVT drive clutch, according to some embodiments. At step 810, the method 800 includes providing a CVT drive clutch. The CVT drive clutch includes any and/or all features of the CVT drive clutch 100 described above. At step 820, the method 800 includes compressing the spring to create a gap between the spider and the movable sheave. For instance, a force can be applied along the arrow 662 on the cover 110 to compress the spring member 222. At step 830, the method 800 includes inserting a stop member between the spider and the movable sheave. The stop member includes any and/or all features of the stop member 550 described above. At step 840, the method 800 includes removing (or servicing) one or more components from the CVT drive clutch. The one or more components are removed without removing the cover 110 from the CVT drive clutch 100.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

### Discussion of Possible Embodiments

In some aspects, the techniques described herein relate to a continuously variable transmission (CVT) drive clutch, including: a stationary sheave; a stationary shaft coupled to the stationary sheave; a movable sheave movable relative to the stationary sheave, the movable sheave including a tower having a cavity therein; and a cover securable to the movable sheave via a fastener extending into the cavity of the tower, wherein an elongate member is received within the cavity of the tower.

In some aspects, the techniques described herein relate to a CVT drive clutch, wherein the elongate member includes an aperture, wherein the fastener extending into the cavity of the tower extends through the aperture of the elongate member.

In some aspects, the techniques described herein relate to a CVT drive clutch, wherein the cover includes an aperture extending therethrough, wherein the elongate member is received within the aperture of the cover and within the cavity of the tower.

In some aspects, the techniques described herein relate to a CVT drive clutch, wherein the fastener is received within the aperture of the cover and within the cavity of the tower.

In some aspects, the techniques described herein relate to a CVT drive clutch, further including a spider positioned between the movable sheave and the cover, and a spring member biasing the movable sheave axially away from the stationary sheave.

In some aspects, the techniques described herein relate to a CVT drive clutch, further including a torque transfer assembly operatively connected to at least one of the spider and the movable sheave, the torque transfer assembly transferring torque between the spider and the movable sheave, the torque transfer assembly including a button slider block assembly.

In some aspects, the techniques described herein relate to a CVT drive clutch, wherein the button slider block assembly is removeable from at least one of the spider and the movable sheave.

In some aspects, the techniques described herein relate to a CVT drive clutch, wherein the movable sheave includes one or more channels recessed within a surface facing the cover, the one or more channels configured to receive a locking ridge of a stop member to restrict axial movement of the movable sheave relative to the cover.

In some aspects, the techniques described herein relate to a CVT drive clutch, further including an identification member secured to the cover and to the tower, wherein disassembly of the cover from the tower damages the identification member.

In some aspects, the techniques described herein relate to a CVT drive clutch, further including an identification member secured to a fastener head of the fastener, wherein disassembly of the fastener from the tower damages the identification member.

In some aspects, the techniques described herein relate to a system for servicing a continuously variable transmission (CVT) drive clutch, the system including: a CVT drive clutch including: a stationary sheave, a stationary shaft coupled to the stationary sheave, a movable sheave movable relative to the stationary sheave and receiving the stationary shaft therethrough, the movable sheave including one or more channels recessed within a surface, a cover securable to the movable sheave, a spider positioned between the movable sheave and the cover, and a spring member biasing the movable sheave axially away from the stationary sheave; and a stop member including a locking ridge, wherein the locking ridge is configured to be received within the one or more channels of the movable sheave.

In some aspects, the techniques described herein relate to a system, wherein the stop member is positioned between the movable sheave and the spider to restrict axial movement of the movable sheave relative to the cover.

In some aspects, the techniques described herein relate to a system, wherein the stop member is positioned between the movable sheave and the spider to hold the spring member in a compressed state.

In some aspects, the techniques described herein relate to a system, wherein the stop member includes a handle extending radially outward from the movable sheave.

In some aspects, the techniques described herein relate to a system further including a torque transfer assembly operatively connected to at least one of the spider and the movable sheave, the torque transfer assembly transferring torque between the spider and the movable sheave, the torque transfer assembly including a button slider block assembly, wherein the stop member is positioned between the movable sheave and the spider to allow removal of the button slider block assembly.

In some aspects, the techniques described herein relate to a method of servicing a continuously variable transmission (CVT) drive clutch, the method including: urging a movable sheave of the CVT drive clutch toward a stationary sheave to create a gap between a spider and the movable sheave, the CVT drive clutch including: the stationary sheave, the movable sheave, a spring member biased to urge the movable sheave axially away from the stationary sheave, the spider, and a cover coupled to a tower of the movable sheave; inserting a stop member into the gap between the spider and the movable sheave; and removing one or more components from the CVT drive clutch.

In some aspects, the techniques described herein relate to a method, wherein the stop member includes a body and a locking ridge extending from the body, wherein the locking ridge is configured to engage a recessed surface on the movable sheave.

In some aspects, the techniques described herein relate to a method, wherein the stop member includes a handle extending radially outward from the movable sheave, wherein the handle is oriented substantially orthogonal to the locking ridge.

In some aspects, the techniques described herein relate to a method, wherein the spider includes a button slider block assembly, wherein the button slider block assembly is removable from the CVT drive clutch.

In some aspects, the techniques described herein relate to a method, wherein the CVT drive clutch includes an identification member secured to the cover and to the tower, wherein disassembly of the cover from the tower damages the identification member.

1. A continuously variable transmission (CVT) drive clutch, comprising:
a stationary sheave;
a stationary shaft coupled to the stationary sheave;
a movable sheave movable relative to the stationary sheave, the movable sheave including a tower having a cavity therein; and
a cover securable to the movable sheave via a fastener extending into the cavity of the tower,
wherein a elongate member is received within the cavity of the tower.

2. The CVT drive clutch of claim 1, wherein the elongate member includes an aperture therethrough, wherein the fastener extending into the cavity of the tower extends through the aperture of the elongate member.

3. The CVT drive clutch of claim 1, wherein the cover includes an aperture extending therethrough, wherein the elongate member is received within the aperture of the cover and within the cavity of the tower.

4. The CVT drive clutch of claim 3, wherein the fastener is received within the aperture of the cover and within the cavity of the tower.

5. The CVT drive clutch of claim 1, further comprising a spider positioned between the movable sheave and the cover, and a spring member biasing the movable sheave axially away from the stationary sheave.

6. The CVT drive clutch of claim 5, further comprising a torque transfer assembly operatively connected to at least one of the spider and the movable sheave, the torque transfer assembly transferring torque between the spider and the movable sheave, the torque transfer assembly including a button slider block assembly.

7. The CVT drive clutch of claim 6, wherein the button slider block assembly is removeable from at least one of the spider and the movable sheave.

8. The CVT drive clutch of claim 6, wherein the movable sheave includes one or more channels recessed within a surface facing the cover, the one or more channels configured to receive a locking ridge of a stop member to restrict axial movement of the movable sheave relative to the cover.

9. The CVT drive clutch of claim 1, further comprising an identification member secured to the cover and to the tower, wherein disassembly of the cover from the tower damages the identification member.

10. The CVT drive clutch of claim 1, further comprising an identification member secured to a fastener head of the fastener, wherein disassembly of the fastener from the tower damages the identification member.

11. A system for servicing a continuously variable transmission (CVT) drive clutch, the system comprising:
a CVT drive clutch including:
a stationary sheave,
a stationary shaft coupled to the stationary sheave,
a movable sheave movable relative to the stationary sheave and receiving the stationary shaft therethrough, the movable sheave including one or more channels recessed within a surface,
a cover securable to the movable sheave,
a spider positioned between the movable sheave and the cover, and
a spring member biasing the movable sheave axially away from the stationary sheave; and
a stop member including a locking ridge, wherein the locking ridge is configured to be received within the one or more channels of the movable sheave.

12. The system of claim 11, wherein the stop member is positioned between the movable sheave and the spider to restrict axial movement of the movable sheave relative to the cover.

13. The system of claim 12, wherein the stop member is positioned between the movable sheave and the spider to hold the spring member in a compressed state.

14. The system of claim 11, wherein the stop member includes a handle extending radially outward from the movable sheave.

15. The system of claim 11 further comprising a torque transfer assembly operatively connected to at least one of the spider and the movable sheave, the torque transfer assembly transferring torque between the spider and the movable sheave, the torque transfer assembly including a button slider block assembly, wherein the stop member is positioned between the movable sheave and the spider to allow removal of the button slider block assembly.

16. A method of servicing a continuously variable transmission (CVT) drive clutch, the method comprising:
urging a movable sheave of the CVT drive clutch toward a stationary sheave to create a gap between a spider and the movable sheave, the CVT drive clutch including:
the stationary sheave,
the movable sheave,
a spring member biased to urge the movable sheave axially away from the stationary sheave,
the spider, and
a cover coupled to a tower of the movable sheave;
inserting a stop member into the gap between the spider and the movable sheave; and
removing one or more components from the CVT drive clutch.

17. The method of claim 16, wherein the stop member includes a body and a locking ridge extending from the body, wherein the locking ridge is configured to engage a recessed surface on the movable sheave.

18. The method of claim 17, wherein the stop member includes a handle extending radially outward from the movable sheave, wherein the handle is oriented substantially orthogonal to the locking ridge.

19. The method of claim 16, wherein the spider includes a button slider block assembly, wherein the button slider block assembly is removable from the CVT drive clutch.

20. The method of claim 16, wherein the CVT drive clutch includes an identification member secured to the cover and to the tower, wherein disassembly of the cover from the tower damages the identification member.
